(19) United States
(12) Patent Application Publication
(10) Pub. No.: US 2006/0085158 A1
(43) Pub. Date: Apr. 20, 2006

(54) Mobile apparatus for testing personal computers

(75) Inventor: Ulvi Cakiner, San Diego, CA (US)

Correspondence Address: FITCH EVEN TABIN & FLANNERY, 120 SOUTH LASALLE SUITE 1600, CHICAGO, IL, 60603, US

(73) Assignees: Sony Corporation, Shinagawa-Ku (JP); Sony Electronics, Park Ridge, NJ (US)

(21) Appl. No.: 10/952,005

(22) Filed: Sep. 27, 2004

(51) Int. Cl. G01M 19/00

(52) U.S. Cl. 702/121; 702/108

(57) ABSTRACT

A mobile apparatus for testing personal computers includes: a test controller; a suite of test equipment coupled to the test controller for testing a plurality of functions of a computer under test; and a floor vehicle on which the test controller and the suite of test equipment are mounted for disposing the computer under test in a test configuration and for transporting the test configuration across a floor.

### BACKGROUND OF THE INVENTION

1. Field of the Invention

The mobile apparatus for testing personal computers disclosed herein relates generally to the manufacture and testing of personal computers, such as desktop and notebook computers. More specifically, the mobile apparatus for testing personal computers disclosed herein relates to testing personal computers in the field.

2. Description of Related Art

The manufacture and maintenance of personal computers (PCs) typically requires testing for product defects. Previous methods for conducting tests on PCs generally involve collecting an assortment of test equipment on a laboratory bench from various locations in a test facility and connecting the test equipment to the computer being tested.

### SUMMARY OF THE INVENTION

In one aspect of the present invention, an apparatus includes:
a test controller;
a suite of test equipment coupled to the test controller for testing a plurality of functions of a computer under test; and
a floor vehicle on which the test controller and the suite of test equipment are mounted for disposing the computer under test in a test configuration and for transporting the test configuration across a floor.

### BRIEF DESCRIPTION OF THE DRAWINGS

A preferred embodiment of a mobile apparatus for testing personal computers is illustrated by way of example and not limitation in the accompanying figures, in which like references indicate similar elements throughout the several views of the drawings, and in which:

FIG. 1 illustrates a block diagram of a mobile apparatus for testing personal computers;

FIG. 2 illustrates a detailed diagram of a floor vehicle for the mobile apparatus for testing personal computers of FIG. 1;

FIG. 3 illustrates a detailed block diagram of a test controller for the mobile apparatus for testing personal computers of FIG. 1;

FIG. 4 illustrates a detailed block diagram of a suite of test equipment for the mobile apparatus for testing personal computers of FIG. 1;

FIG. 5 illustrates an exemplary mobile apparatus for testing a desktop personal computer constructed according to the block diagram of FIG. 1;

FIG. 6 illustrates an exemplary mobile apparatus for testing a notebook personal computer constructed according to the block diagram of FIG. 1; and

FIG. 7 illustrates an exemplary schematic for the power supply test port of FIG. 1.

The elements shown in the figures are illustrated for simplicity and clarity and have not necessarily been drawn to scale. For example, the dimensions of some elements in the figures may be exaggerated relative to other elements to point out distinctive features in the illustrated embodiments of the present invention described below.

### DESCRIPTION OF THE ILLUSTRATED EMBODIMENTS

The collection of test equipment on a laboratory bench typically used for testing personal computers (PCs) during manufacturing and maintenance has several disadvantages. One disadvantage of the laboratory bench approach to testing computers, for example, desktop PCs, notebook PCs, and other types of devices that perform a programmed sequence of instructions, is that the test equipment is often moved from one laboratory bench to another, resulting in frequently misplaced test equipment and disorganized test setups. Another disadvantage is that the laboratory bench may not be readily transported into the field, nor may a laboratory bench be moved easily from the test facility to the production floor where computer testing is often needed.

The mobile apparatus for testing personal computers disclosed herein overcomes the disadvantages described above and also provides a fully capable computer test configuration on a conveniently mobile floor vehicle. For example, the mobile apparatus for testing personal computers may perform functional tests on all the internal and peripheral components in the computer to be tested. The test configuration may be readily transported by the floor vehicle, for example, from a test center to a field site for on-site maintenance at a customer facility. Also, the floor vehicle may be easily moved around the production floor to investigate problems during assembly and into a private conference room to demonstrate specific problems to vendors.

In one aspect of a mobile apparatus for testing personal computers, an apparatus includes:
a test controller;
a suite of test equipment coupled to the test controller for testing a plurality of functions of a computer under test; and
a floor vehicle on which the test controller and the suite of test equipment are mounted for disposing the computer under test in a test configuration and for transporting the test configuration across a floor.

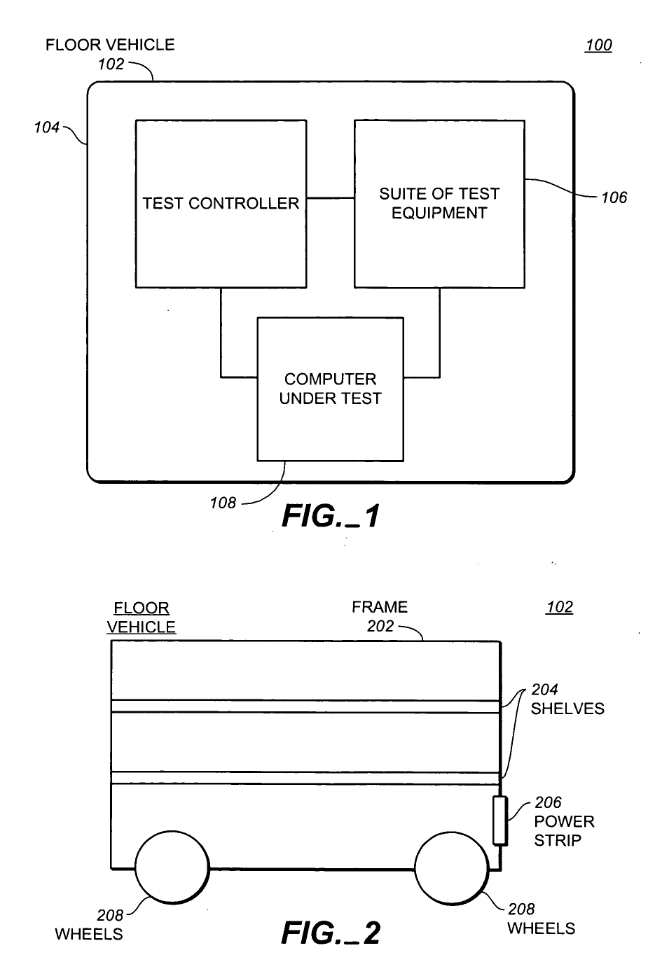

FIG. 1 illustrates a block diagram 100 of a mobile apparatus for testing personal computers according to an embodiment of the present invention. Shown in FIG. 1 are a floor vehicle 102, a test controller 104, a suite of test equipment 106, and a computer under test 108.

The a test controller 104 is connected to the suite of test equipment 106 to transmit test commands and data to the suite of test equipment 106 and the computer under test 108 and to receive test results from the suite of test equipment 106 and the computer under test 108. The test controller 104, the suite of test equipment 106, and the computer under test 108 are all arranged in a test configuration on the floor vehicle 102 so that the test configuration may be conveniently moved across a floor, for example, of a test facility, a production area, or a presentation site.

FIG. 2 illustrates a detailed diagram of a floor vehicle 102 for the mobile apparatus for testing personal computers of FIG. 1. Shown in FIG. 2 are a frame 202, shelves 204, a power strip 206, and wheels 208.

In FIG. 2, the frame 102 is constructed from a suitable material, for example, sheet metal, according to well known mechanical techniques to support the shelves 204, the power strip 206, and the wheels 208. The frame 102 may also include brackets and fasteners, for example, for holding notebook computer displays and docking stations. The shelves 204 are preferably flat and parallel with the plane of the wheels to support the test controller 104, the suite of test equipment 106, and the computer under test 108. The power strip 206 may be, for example, a standard multiple outlet power strip used to supply 120 VAC. The power strip 206 may be fastened to the frame 102 according to well known techniques and may also be fused to avoid possible damage from an overloaded circuit. The wheels 208 may be, for example, wheels generally used for tool carts and other floor vehicles, or the wheels 208 may be other suitable devices, for example, skids or casters, for moving the floor vehicle 102 conveniently across a floor. A floor may be any surface suitable for transporting equipment or personnel from one location to another. Alternatively, an existing tool cart such as an oscilloscope cart may be used or adapted for use according to well known techniques to make the floor vehicle 102.

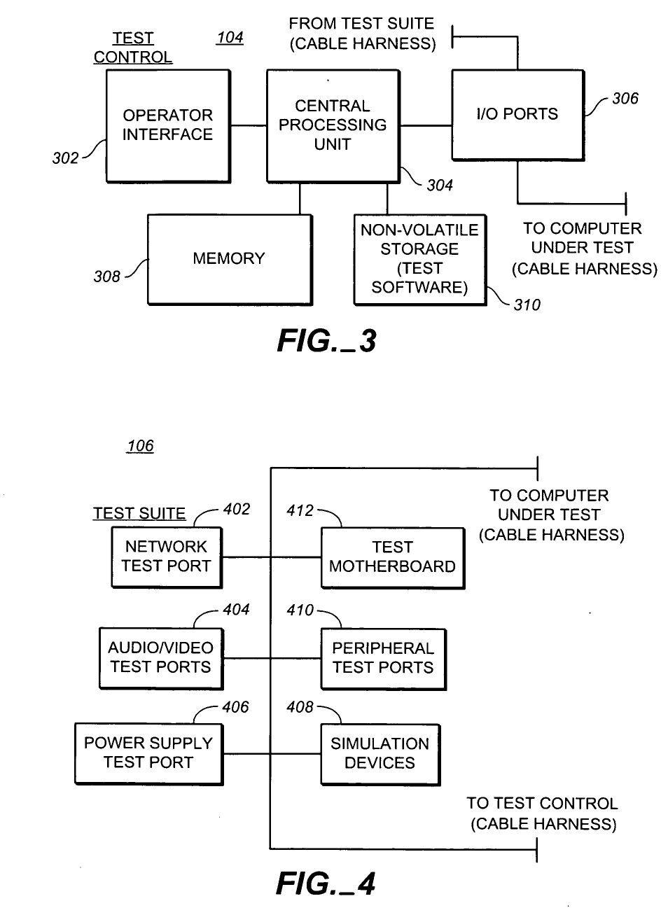

FIG. 3 illustrates a detailed block diagram of a test controller 104 for the mobile apparatus for testing personal computers of FIG. 1. Shown in FIG. 3 are an operator interface 302, a central processing unit 304, I/O ports 306, a computer memory 308, and non-volatile storage for test software.

In FIG. 3, the test controller 104 is connected to the suite of test equipment 106 and to the computer under test 108 by a test cable harness that includes appropriate connectors for making the connections to the suite of test equipment 106 and to the computer under test 108. The connectors include, for example, a main power connector, an electrostatic discharge grounding connector, a floppy disk drive connector, a hard disk drive connector, an optical drive connector, a serial port connector, a parallel port connector, a video port connector, an audio port connector, an I-LINK port connector, a modem connector, and a docking station connector.

The operator interface 304 includes, for example, a display monitor, a keyboard, a pointing device, a printer, and any other suitable device for communications between a test operator and the test software. The central processing unit 304 may be, for example, a “golden”, that is, defect free, computer motherboard used in desktop personal computers. The “golden” motherboard may also include a central processing unit chip and the computer memory 308. The computer memory 308 may be any type of suitable memory device used for reading and writing computer data. The I/O ports 306 may be, for example, standard serial and parallel data ports used for communications between a computer and computer peripheral devices, for example, a telephone modem, a USB port, and so on. The I/O ports 306 may also be included on the “golden” motherboard. The non-volatile storage 310 may be, for example, a hard disk drive used in desktop computers. The non-volatile storage 310 holds the test software, which may be, for example, commercially available software for testing personal computers or special test software developed in-house for exercising the functions of the computer under test and analyzing test results gathered from the computer under test.

FIG. 4 illustrates a detailed block diagram of a suite of test equipment 106 for the mobile apparatus for testing personal computers of FIG. 1. Shown in FIG. 4 are a network test port 402, audio/video test ports 404, a power supply test port 406, simulation devices 408, peripheral test ports 410, and a test motherboard 412. The network test ports 402 may include, for example, commercially available or custom test devices for testing local area network (LAN) interface devices, and so on. The audio/visual test ports 404 may include tone generators and video signal generators for testing sound cards, video processors, and the like. The power supply test ports 406 may include, for example, power monitoring equipment to detect voltage spikes and droops. The simulation devices 408 may include, for example, telephone line simulators for testing telephone modems. The peripheral test ports 410 may include, for example, interfaces for testing peripheral devices such as I-LINK, keyboards, floppy disk drives, modems, hard disk drives, and so on. The suite of test equipment may also include a voltmeter, an oscilloscope, and other electronic measurement devices.

The computer under test 108 may be, for example, a desktop personal computer, a notebook personal computer, or any other type of computing device that performs a programmed sequence of instructions.

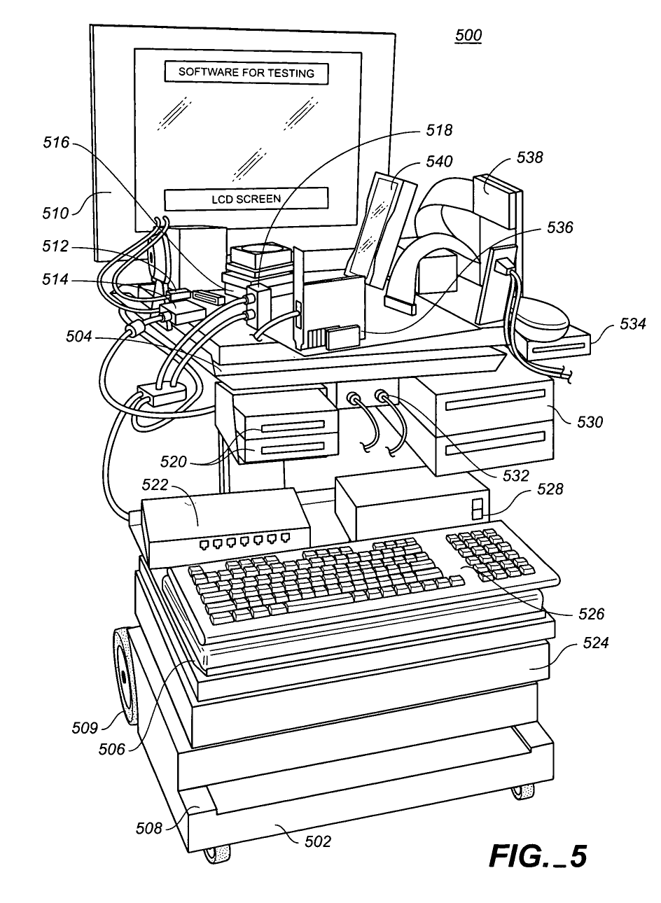

FIG. 5 illustrates an exemplary mobile apparatus 500 for testing a desktop personal computer constructed according to the block diagram of FIG. 1. Shown in FIG. 5 are a floor vehicle 502, shelves 504, 506, and 508, wheels 509, a display 510, a control test port 512, a video test port 514, a CPU assembly test socket 516, a network test port 518, hard disk drive test bays 520, a telephone line test unit 522, an I-LINK test bay 524, a keyboard test unit 526, a tone generator 528, an optical drive test bay 530, an electrostatic discharge (ESD) connector 532, a floppy drive test bay 534, a modem test slot 536, an audio test connector 538, and a test control hard disk drive 540.

In the example of FIG. 5, the three shelves 504, 506, and 508 are mounted on a frame that also supports the wheels 509. The computer display 510 is an LCD display that is mounted on the top shelf 504 of the floor vehicle 502 to monitor test results. The bracket may be adjusted to accommodate a variety of display sizes and types. A motherboard, which may be from a computer under test or a “golden” motherboard, is also located on the top shelf that includes the control test port 512, the video test port 514, the CPU assembly test socket 516, the network test port 518, the modem test slot 536, the audio test connector 538, and the test control hard disk drive 540.

The control test port 512 is a PS2 connector typically used for connecting keyboards to computer. The video test port 514 includes a video connector for connecting a video cable to a computer display monitor. The CPU assembly test socket 516 includes a CPU socket, a heatsink, and fan for testing CPU integrated circuits. The network test port 518 includes a connector for an Ethernet cable. The modem test slot 536 accepts a modem card for testing. The audio test connector 538 includes RCA jacks for connecting audio cables. The test control hard disk drive 540 is used to store the test software.

Fastened to the bottom of the top shelf 504 are the hard disk drive test bay 520, the optical drive test bay 530, the electrostatic discharge (ESD) connector 532, and a floppy drive test bay 534. The hard disk drive test bay 520 may be used to insert one or more hard disk drives for testing, the optical drive test bay 530 may be used to insert one or more optical disk drives for testing, and the floppy drive test bay 534 may be used to insert one or more floppy disk drives for testing. The electrostatic discharge (ESD) connector 532 may be used to connect the floor vehicle 502 to ground to protect the test configuration from damage to due static discharge.

The telephone line test unit 522, the keyboard test unit 526, and the tone generator 528 are mounted on the middle shelf 506, and the I-LINK test bay 524 is mounted on the bottom shelf 508.

As may be appreciated from FIG. 5, a complete test capability for personal computers is assembled on a conveniently mobile platform that may be used in a plant or in the field.

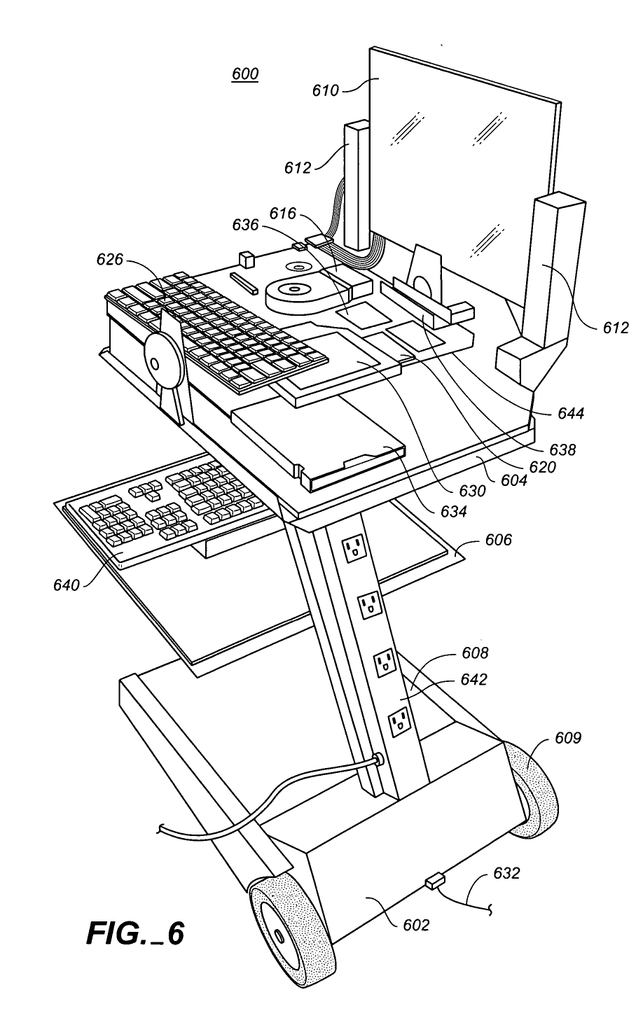

FIG. 6 illustrates an exemplary mobile apparatus 600 for testing a notebook personal computer constructed according to the block diagram of FIG. 1. Shown in FIG. 6 are a floor vehicle 602, shelves 604, 606, and 608, wheels 609, a display 610, display brackets 612, a CPU assembly test socket 616, a hard disk drive test bay 620, a keyboard test unit 626, an optical drive test bay 630, an electrostatic discharge (ESD) connector 632, a floppy drive test bay 634, a base unit MBX test slot 636, an audio test connector 638, a test controller 640, a power strip 642, and a docking station 644.

In the example of FIG. 6, the three shelves 604, 606, and 608 are mounted on frame that also supports the wheels 609 and the power strip 642. The computer display 610 is an LCD display that is mounted on the display brackets 612 on the top shelf 604 of the floor vehicle 602 to monitor test results. The display brackets 612 may be adjusted to accommodate a variety of display sizes and types. A motherboard, which may be from a computer under test or a “golden” motherboard, is also located on the top shelf that includes the CPU assembly test socket 616, the hard disk drive test bay 620, the optical drive test bay 630, the base unit MBX test slot 636, and the audio test connector 638.

The CPU assembly test socket 616 includes a CPU socket, a heatsink, and fan for testing CPU integrated circuits. The audio test connector 638 includes standard jacks for connecting audio cables.

In the example of FIG. 6, the middle shelf 606 holds the test controller 640. The bottom shelf 608 may be used for other test equipment, and the electrostatic discharge (ESD) connector 632 may be used to connect the floor vehicle 502 to ground to protect the test configuration from damage to due static discharge.

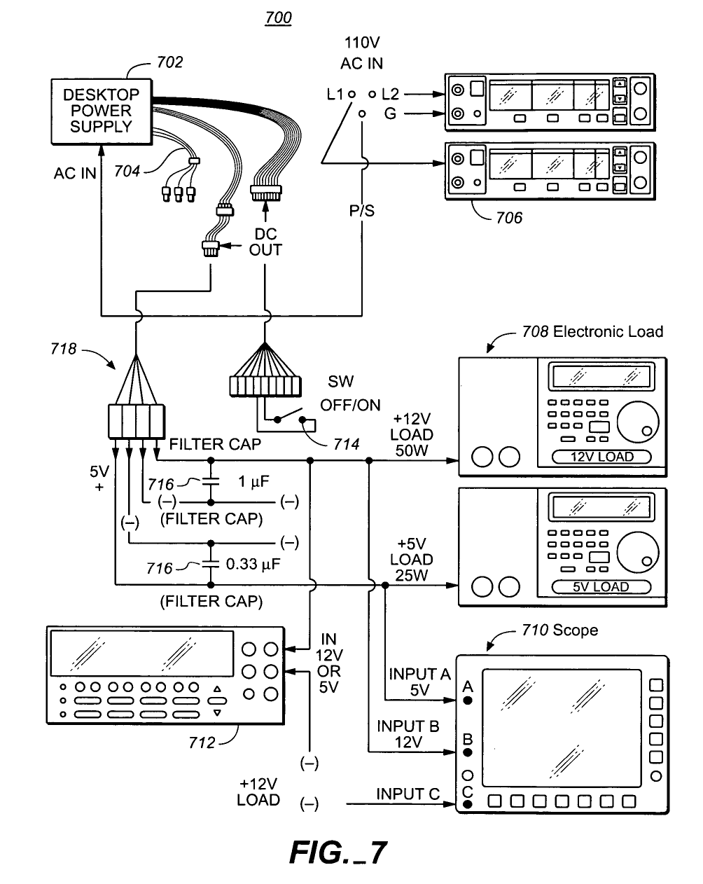

FIG. 7 illustrates an exemplary schematic 700 for the power supply test port of FIG. 4. Shown in FIG. 7 are a desktop personal computer power supply 702, power cables 704, megohm test meters 706, programmable load devices 708, an oscilloscope 710, a voltmeter 712, a test switch 714, filter capacitors 716, and a test cable harness 718.

In FIG. 7, the desktop personal computer power supply 702 may be disconnected from the computer under test and connected to the megohm test meters 706, the programmable load devices 708, the oscilloscope 710, and the voltmeter 712 of the suite of test equipment via the power cables 704 and the test cable harness 718. The cable harness 718 includes the test switch 712, which is used to switch the power supply 702 on and off. The filter capacitors 716 are selected to remove any high frequency AC noise that may be present on the voltage outputs of the power supply 702.

The test cable harness 718 includes a connector for supplying 120 VAC to the power supply 702 and to connect the power supply leads to the megohm test meters 706 to detect possible ground faults in the power supply.

The test cable harness 718 also includes wiring to connect the 12 V and 5 V outputs of the power supply 702 to the programmable load devices 708, the oscilloscope 710, and the voltmeter 712 of the suite of test equipment. The programmable load devices 708 provide appropriate test loads for measuring the voltage output of the power supply 702, for example, a 50 W load for the 12 V output and a 25 W load for the 5 V output. The oscilloscope 710 may be used to analyze the waveform of the voltage outputs of the power supply 702, for example, to detect intermittent power spikes or droop. The voltmeter 712 may be used to check the level of either the 12 V output or the 5 V output of the power supply 702.

While the mobile apparatus for testing personal computers herein disclosed has been described by means of specific embodiments and applications thereof, numerous modifications and variations may be made thereto by those skilled in the art without departing from the scope of the following claims.

What is claimed is:

1. An apparatus comprising:
a test controller;
a suite of test equipment coupled to the test controller for testing a plurality of functions of a computer under test; and
a floor vehicle on which the test controller and the suite of test equipment are mounted for disposing the computer under test in a test configuration and for transporting the test configuration across a floor.

2. The apparatus of claim 1 further comprising a cable harness for connecting and disconnecting the test controller and the suite of test equipment to and from the computer under test.

3. The apparatus of claim 2 further comprising a connector coupled to the cable harness for connecting and disconnecting the cable harness to and from the computer under test.

4. The apparatus of claim 3 wherein the connector includes at least one of a main power connector, an electrostatic discharge grounding connector, a floppy disk drive connector, a hard disk drive connector, an optical drive connector, a serial port connector, a parallel port connector, a video port connector, an audio port connector, an I-LINK port connector, a modem connector, and a docking station connector.

5. The apparatus of claim 1 wherein the test controller comprises an operator interface.

6. The apparatus of claim 5 wherein the operator interface comprises a keyboard, a display, and a pointing device.

7. The apparatus of claim 1 wherein the test controller further comprises a central processing unit, a memory, non-volatile storage, and I/O ports.

8. The apparatus of claim 7 wherein the test controller further comprises a central processing unit fan, a “golden” motherboard, a floppy disk drive, a hard disk drive, an optical drive, a serial port, a parallel port, a video port, an audio port, an I-LINK port, a modem, a docking station, and a power supply.

9. The apparatus of claim 8 wherein the suite of test equipment comprises a power supply test port that comprises a switch for switching the power supply between the computer and a test load.

10. The apparatus of claim 9 wherein the power supply test port further comprises the test load and at least one of a power leakage tester, a voltmeter, and an oscilloscope.

11. The apparatus of claim 1 wherein the suite of test equipment further comprises at least one of a tone generator and a modem simulator.

12. The apparatus of claim 1 wherein the floor vehicle has a size suitable for moving conveniently about a test laboratory, a production floor, a repair facility, and a conference room.

13. The apparatus of claim 1 wherein the computer is one of a desktop computer, a notebook computer, a laptop computer, a handheld computer, and any device that can perform a sequence of programmed instructions.

14. An apparatus comprising:
a test controller;
a suite of test equipment coupled to the test controller for testing a plurality of functions of a computer under test;
a floor vehicle on which the test controller and the suite of test equipment are mounted for disposing the computer under test in a test configuration and for transporting the test configuration;
a cable harness for connecting and disconnecting the suite of test equipment to and from the computer; and
a connector coupled to the cable harness for connecting and disconnecting the cable harness to and from the computer under test,
wherein the test controller comprises an operator interface, a central processing unit, a computer test program, a central processing unit fan, a memory, a motherboard, a floppy disk drive, a hard disk drive, an optical drive, a serial port, a parallel port, a video port, an audio port, an I-LINK port, a modem, a docking station, and a power supply;
wherein the connector further comprises a main power connector, an electrostatic discharge grounding connector, a floppy disk drive connector, a hard disk drive connector, an optical drive connector, a serial port connector, a parallel port connector, a video port connector, an audio port connector, an I-LINK port connector, a modem connector, and a docking station connector;
wherein the operator interface further comprises a keyboard, a display, and a pointing device;
wherein the test controller further comprises a central processing unit, a computer test program, a central processing unit fan, a “golden” motherboard, a floppy disk drive, a hard disk drive, an optical drive, a serial port, a parallel port, a video port, an audio port, an I-LINK port, a modem, a docking station, and a power supply;
wherein the suite of test equipment further comprises a power supply test port that comprises a switch for switching an output of the power supply between the computer and a test load, the test load, a power leakage tester, a voltmeter, an oscilloscope, a tone generator, and a modem simulator; and
wherein the floor vehicle has a size suitable for moving conveniently about inside a test laboratory, a production floor, a repair facility, and a conference room.
